(19) United States
(12) Patent Application Publication
(10) Pub. No.: US 2019/0065441 A1
(43) Pub. Date: Feb. 28, 2019

(54) METHOD FOR EDITING CHARACTERS ON SMART DEVICE INCLUDING TOUCH SCREEN AND SMART DEVICE FOR IMPLEMENTING SAME

(71) Applicant: PIANO CO., LTD., Gyeonggi-do (KR)

(72) Inventor: Chan Gi KIM, Gyeonggi-do (KR)

(21) Appl. No.: 16/173,618

(22) Filed: Oct. 29, 2018

Related U.S. Application Data
(63) Continuation of application No. PCT/KR2018/000145, filed on Jan. 4, 2018.

(30) Foreign Application Priority Data
Jan. 6, 2017 (KR) 10-2017-0002237

(51) Int. Cl. G06F 17/21; G06F 3/01; G06T 13/80; G06F 17/24; G06F 3/0484

(52) U.S. Cl. CPC G06F 17/214; G06F 3/017; G06F 17/11; G06F 17/24; G06F 3/0484; G06T 13/80

(57) ABSTRACT

The present inventive concept relates to a method for editing characters on a smart device including a touch screen and a smart device for implementing the same and, more specifically, to a touch-based user interface for simultaneously touching and editing characters to be edited on a touch screen, and the user interface, by which visual recognition and convenience of a touch operation are improved, is provided such that the characters can be edited more intuitively by the user through the character editing method of the present inventive concept.

### TECHNICAL FIELD

The present inventive concept relates to a method for editing characters on a smart device including a touch screen and a smart device for implementing the same, and more particularly, a touch-based user interface for simultaneously touching and editing characters to be edited on a touch screen.

### BACKGROUND ART

A touch screen is a screen that finds a user's touch location thereon and is generally classified into a resistive type, a capacitive type, an inductive type, or an acoustic type.

Recently, a handheld electronic device using a touch screen, such as a tablet PC, a personal digital assistant (PDA), a smartphone, or the like, is on the increase. Accordingly, a user interface having an improved user convenience or an improved operation flexibility using a touch screen has been realized.

However, a conventional user interface does not provide a simple, intuitive character editing method. According to a conventional character editing method illustrated in FIG. 1, when a user touches a screen on which a character is located, the character is specified, and characters to be edited are determined by dragging from a specified start position to a specified end position. Then, the user can edit text by selecting an editing function such as copy, cut, paste, or the like.

The conventional character editing method, however, takes more time than necessary and is not efficient because the user is required to undergo several editing steps.

### DISCLOSURE

### Technical Problems

To address the aforementioned problems, exemplary embodiments of the present inventive concept provide a smart device having a user interface with an improved visual recognition and an improved convenience of touch manipulation so that a user can edit characters more intuitively, and a method for editing characters.

Additional advantages, subjects, and features of the present inventive concept will be set forth in part in the description which follows and in part will become apparent to those having ordinary skill in the art upon examination of the following or may be learned from practice of the present inventive concept.

### Technical Solutions

According to an aspect of the present inventive concept, there is provided a method for editing characters on a smart device including a touch screen, comprising, displaying text to be displayed on the touch screen, detecting a touch point on the touch screen, determining coordinates, on the touch screen, of the detected touch point and coordinates, on the touch screen, of each character included in the text, detecting a first touch gesture crossing over a character to be edited from the text displayed on the touch screen, based on the determined coordinates and editing a character displayed on the touch screen, corresponding to the coordinates of the touch point, based on the detected first touch gesture, wherein the editing the character, comprises editing the character by displaying an animation effect for the character, and the animation effect displayed for the character displays the character to stick out above the touch point.

According to another aspect of the inventive concept, there is provided a smart device editing characters via a touch screen, comprising, a display unit displaying text on the touch screen, a touch point detection unit detecting a touch point on the touch screen, a coordinate determination unit determining coordinates, on the touch screen, of the detected touch point and coordinates, on the touch screen, of each character included in the text, a touch gesture detection unit detecting a first touch gesture crossing over a character to be edited from the text displayed on the touch screen, based on the determined coordinates and an editing unit editing a character displayed on the touch screen, corresponding to the coordinates of the touch point, based on the detected first touch gesture, wherein the editing unit edits the character displayed on the touch screen, corresponding to the coordinates of the touch point, based on the detected first touch gesture by displaying an animation effect for the character, and the animation effect displayed for the character displays the character to stick out above the touch point.

According to another aspect of the inventive concept, there is provided a user interface for editing characters via a touch screen of a smart device, comprising, a text display region; and an editing mode selection region, wherein a character from text displayed on the touch screen, corresponding to coordinates of a touch point on the text display region, is edited in accordance with an editing mode selected from the editing mode selection region, based on a touch gesture crossing, from the touch point, over the character, the character displayed in the text display region is edited in accordance with the editing mode selected from the editing mode selection region, while accompanying an animation effect, and the animation effect makes the character stick out above the touch point.

### Advantageous Effects

According to one exemplary embodiment of the present inventive concept, when a user touches a character to be edited from a touch screen and drags in a direction toward the character to be edited, an edited character may directly be displayed on the screen. Thus, the user can intuitively edit characters.

Also, since an animation effect is applied to a character string currently being edited so that the character string can move from its original location, it is possible to easily recognize visually which character is being edited or being editing-canceled.

According to one exemplary embodiment of the present inventive concept, since a character at a touched location is displayed to stick out above a character string that it belongs to, the character at the touched location can be prevented from being hidden from view by a finger.

### BRIEF DESCRIPTION OF DRAWINGS

FIG. 1 illustrates a conventional character editing method.

FIG. 2 is a configuration view of a smart device editing characters via a touch screen, according to an exemplary embodiment of the present inventive concept.

FIG. 3 is a schematic view of a screen from which characters are touched according to an exemplary embodiment of the present inventive concept.

FIGS. 4A through 4G are schematic views sequentially illustrating screens for editing characters via a touch screen, according to an exemplary embodiment of the present inventive concept.

FIGS. 5A through 5G are schematic views sequentially illustrating screens for canceling the editing of characters that are edited via a touch screen, according to an exemplary embodiment of the present inventive concept.

FIGS. 6A through 6G are schematic views sequentially illustrating screens for editing characters according to another exemplary embodiment of the present inventive concept.

FIGS. 7A through 7G are schematic views sequentially illustrating screens for canceling the editing of characters that are edited, according to another exemplary embodiment of the present inventive concept.

FIG. 8 is a flowchart illustrating a method for editing characters on a smart device including a touch screen, according to an exemplary embodiment of the present inventive concept.

FIG. 9 is a flowchart illustrating a method for editing characters on a smart device including a touch screen, while displaying an animation effect, according to another exemplary embodiment of the present inventive concept.

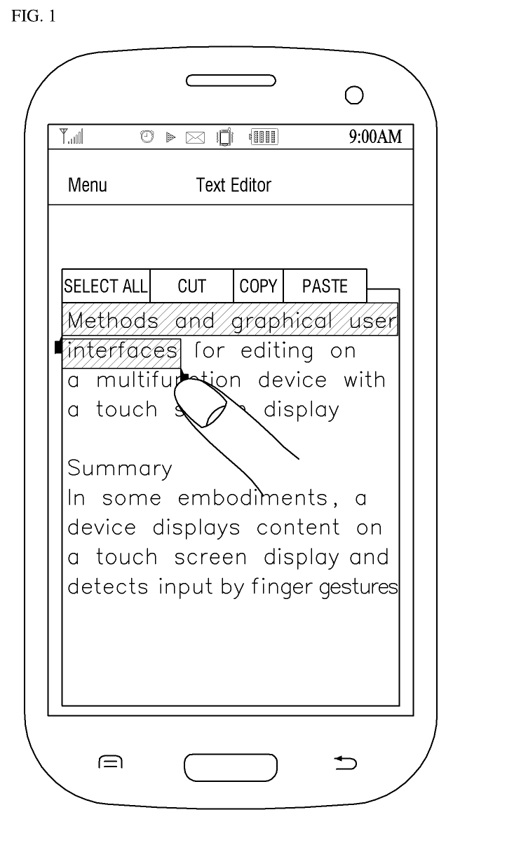

### BEST MODES FOR CARRYING OUT THE INVENTION

Hereinafter, preferred embodiments of the present invention will be described with reference to the attached drawings. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like numbers refer to like elements throughout.

Unless otherwise defined, all terms including technical and scientific terms used herein have the same meaning as commonly understood by one of ordinary skill in the art to which this invention belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular are intended to include the plural forms as well, unless the context clearly indicates otherwise.

It will be understood that the terms “comprise” and/or “comprising” when used herein, specify some stated components, steps, operations and/or elements, but do not preclude the presence or addition of one or more other components, steps, operations and/or elements.

Exemplary embodiments of the present inventive concept can be implemented using various means. For example, exemplary embodiments of the present inventive concept can be implemented by hardware, firmware, software, or a combination thereof.

The term “text”, as used herein, encompasses plain text, unstructured text, formatted text, and may also encompass characters (or letters), emoticons, and words.

The term “character”, as used herein, may encompass characters or letters from a language system such as Korean, English, Chinese, or Japanese characters and special characters such as numbers, symbols, or signs.

The expression “two elements corresponding to each other”, as used herein, means that the two elements have the same location or are within a predetermined range of each other. Specifically, a character on a touch screen, corresponding to the coordinates of a touch point, may mean that the coordinates of the touch point are the same as the location of the character on the touch screen, or may refer to a character on the touch screen closest to the coordinates of the touch point.

Also, the term “animation”, as used herein, may encompass motion of a character, enlargement of a character, or a special effect (e.g., a glowing star, a firework, etc.) that can be applied to or around characters.

Exemplary embodiments of the present inventive concept will hereinafter be described with reference to the accompanying drawings.

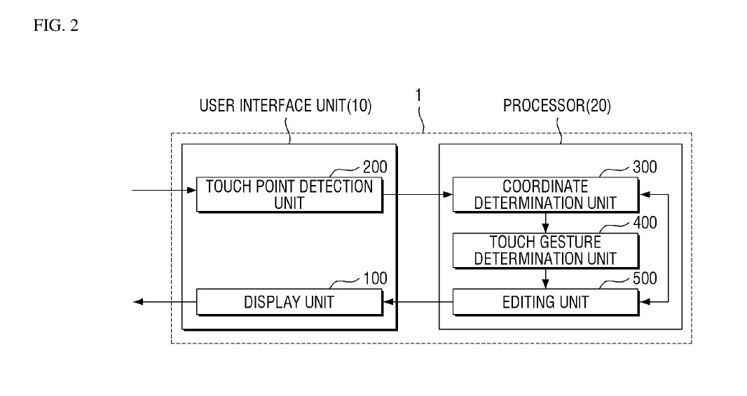

FIG. 2 is a configuration view of a smart device editing characters via a touch screen, according to an exemplary embodiment of the present inventive concept.

Referring to FIG. 2, a smart device 1 may include a user interface unit 10, which includes a touch point detection unit 200 and a display unit 100, and a processor 20, which includes a coordinate determination unit 300, a touch gesture determination unit 400, and an editing unit 500.

The processor 20 may be implemented as an array of multiple logic gates or may be implemented as a combination of a microprocessor and a memory in which programs that can be executed by the microprocessor are stored. It is obvious to a person skilled in the art to which the present exemplary embodiment pertains that the processor 20 may also be implemented as other types of hardware. In this specification, only hardware components related to the present exemplary embodiment will be described for clarity, but it may be understood that other general-purpose hardware components than those illustrated in FIG. 2 can also be included.

The smart device 1 of FIG. 2 may be a mobile communication terminal, a tablet PC, an electronic notebook, a personal digital assistant (PDA), a kiosk, or the like.

A touch screen is a type of screen detecting the location of a character or a particular location thereon, touched by a hand of a user or an object, without the use of an external input device such as a mouse or a keyboard, and allowing a predetermined process corresponding to the detected location to be performed.

According to the present inventive concept, when the user touches a character displayed on the touch screen with a finger or a pen, the touched character can be displayed differently from other non-touched characters, the touched character can be edited in accordance with the user's touch gesture crossing over the touched character, and an animation effect can be applied to the touched character so that the touched character can be easily identified visually while being edited.

The display unit 100 displays text on the touch screen, and the touch point detection unit 200 can detect a touch point on the touch screen.

The touch point detection unit 200 recognizes the user's touch in a pressure sensitive manner or a capacitive manner. The pressure sensitive manner is a method of detecting the pressure of a location on the touch screen, touched by the user, to receive the touched location, and the capacitive manner is a method of detecting a current flowing in a part of the body of the user such as a finger to receive a location touched by the user. The touch point detection unit 200 is not particularly limited to being realized in the pressure sensitive manner or the capacitive manner, and may be realized in any other manners.

The coordinate determination unit 300 processes information corresponding to coordinates transmitted by the touch point detection unit 200. That is, the coordinate determination unit 300 may determine and process the coordinates (on the touch screen) of the touch point and the coordinates (on the touch screen) of a character at a location touched by the user.

If the coordinates of the location touched by the user correspond to a function key or an icon executing a particular command, the coordinate determination unit 300 may enable the particular command to be executed. For example, a type of editing function to be performed may be selected.

Accordingly, the coordinate determination unit 300 may receive a selection of an editing mode for each character. The editing mode may be, but is not limited to, at least one of boldface, font color change, italic, highlight, shade, strike-through, tilt, crop, copy, and paste.

The touch gesture determination unit 400 may detect a touch gesture crossing over a character displayed on the touch screen based on the coordinates determined by the coordinate determination unit 300.

Specifically, when the user touches the touch screen with a finger or a pen and moves the finger or the pen over the touch screen, a determination may be made as to whether vertical coordinates Ys and Yc of an initial touch point and a current touch point, among a series of touch points, are the same, thereby determining a crossing touch gesture first. If the vertical coordinate Ys of the initial touch point and the vertical coordinate Yc of the current touch point are not the same, character editing may not be performed, and the touch screen may be scrolled up or down.

If the touch gesture determination unit 400 detects a touch gesture crossing horizontally, the editing unit 500 may edit the character displayed on the touch screen, corresponding to the touch coordinates of the touch point. Then, the edited character may be displayed on the touch screen via the display unit 100.

Also, the editing unit 500 may display an animation effect along with each character and may thus edit each character. Even when editing is canceled, the editing unit 500 may also display an animation effect for each edited character and may thus cancel editing of each edited character.

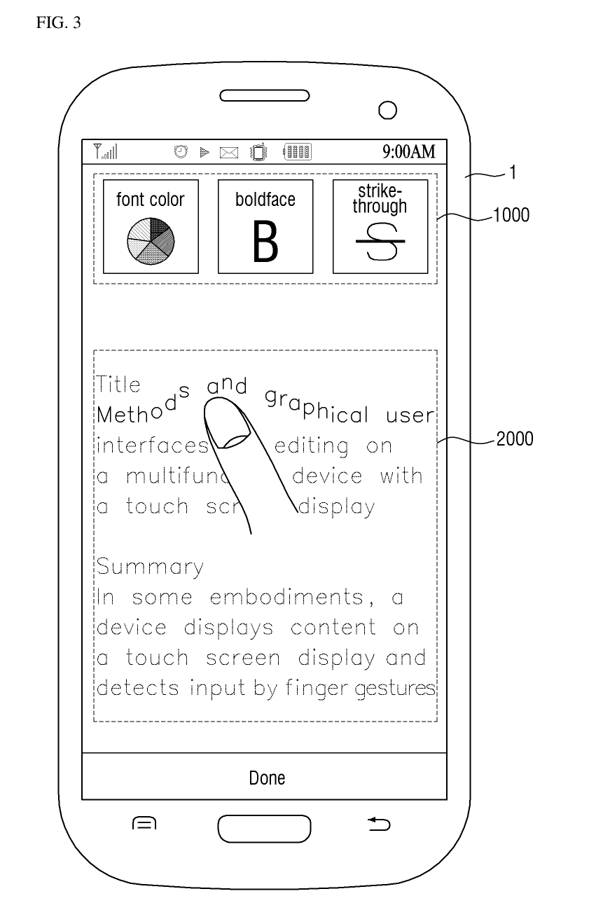

FIG. 3 is a schematic view of a screen from which characters are touched according to an exemplary embodiment of the present inventive concept.

If the touch gesture determination unit 400 detects a touch gesture crossing horizontally, the editing unit 500 may change, as an animation effect, the location of a character at a location touched by the user such that the character can stick out above the touched location, as illustrated in FIG. 3.

Specifically, the editing unit 500 may change the location of the character at the touched location and the locations of multiple characters in the same character string as, and located near, the character at the touched location so that the corresponding character string can stick out above the touched location.

The animation effect may make characters near the touched location move along a touch drag direction while forming a particular shape, but the present inventive concept is not limited thereto.

In order to display the animation effect, the location of a character may be changed by changing the coordinates of the character in accordance with a predetermined relationship between a distance x between the coordinates of the touch point and the coordinates of the character and an effect height h.

The predetermined relationship forms a particular shape into which the character at the touched location moves and may be defined as the following function (S₁).

S₁: y′ₜ=h×cos((π/2)·α·x)×p+yₜ(−α<x<α)

{cf. y′ₜ=character vertical coordinate after change; y′ₜ=character vertical coordinate is before change;

h=effect height; α=function cycle;

x=current touch point (X_{c})-horizontal coordinate (Xₜ) of character;

p=1/T×t; T is optional}

That is, the effect height h is the maximum height to which the character sticks out in response to its coordinates being changed, a denotes the width of the shape in which the character sticks out, x denotes the distance between the touch point and the horizontal coordinate of the character, and p denotes progress in the animation effect.

The progress p is 0 when no progress is made, and becomes 1 when completed. The progress p always has a value between 0 and 1.

Also, the horizontal and vertical coordinates of the character may be the x and y coordinates of the center, the far left side, or the far right side of the character.

The predetermined relationship may also be defined by the following function (S₂).

S₂: y′ₜ=h×(x−α)²×(x+α)²÷α⁴+yₜ(−α<x<α).

That is, a function for determining the shape of the character by changing the coordinates of the character may be defined as, but is not limited to, S₁ or S₂ and may be defined as various other functions such as a combination of sine and cosine functions or an exponential function.

As illustrated in FIG. 3, since the character at the touched location sticks out above the touched location, the character at the touched location can be prevented from being hidden from view by a finger.

Meanwhile, when an uppermost character string sticks out above the touched location, the coordinates of each character therein may be changed to the outside of a text display region, and thus, the character string may not be displayed on the screen.

In order to address this problem, a new screen having the screen size of the touch screen is set as an uppermost layer, and the character string at the touched location is displayed in the uppermost layer, thereby preventing the character string at the touched location from being hidden from view. This solution may overcome the limits of application programs utilizing existing smart devices.

The touch gesture determination unit 400 may determine whether to edit a character or cancel editing of an edited character.

When the touch point is moved, i.e., when a horizontal coordinate Xc of the current touch point becomes different from a horizontal coordinate Xs of the initial touch point, the touch gesture determination unit 400 may determine whether the user's touch is moved to the right to edit a character or is moved to the left to cancel editing of an edited character.

Accordingly, if a coordinate Xl of a far left touch point among the series of touch points is to the left of a coordinate Xt of a character and the coordinate Xc of the current touch point is to the right of the coordinate Xt of the character (i.e., Xl<Xₜ<Xc), the touch gesture determination unit 400 determines the user's touch gesture as being a first touch gesture for editing a character.

Also, if a coordinate Xr of a far right touch point among the series of touch points is to the right of the coordinate Xt of the character and the coordinate Xc of the current touch point is to the left of the coordinate Xt of the character (i.e., Xc<Xt<Xr), the touch gesture determination unit 400 determines the user's touch gesture as being a second touch gesture for canceling editing of an edited character.

When the user's touch gesture is determined as being the first touch gesture by the touch gesture determination unit 400, the editing unit 500 may edit the character corresponding to the coordinates of the touch point or may display an animation effect, and at the same time, edit the corresponding character.

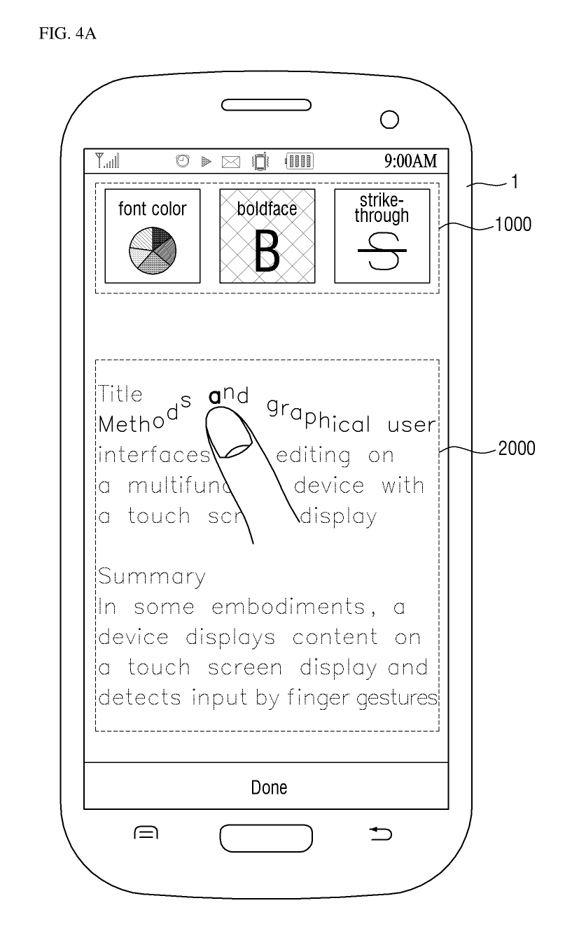

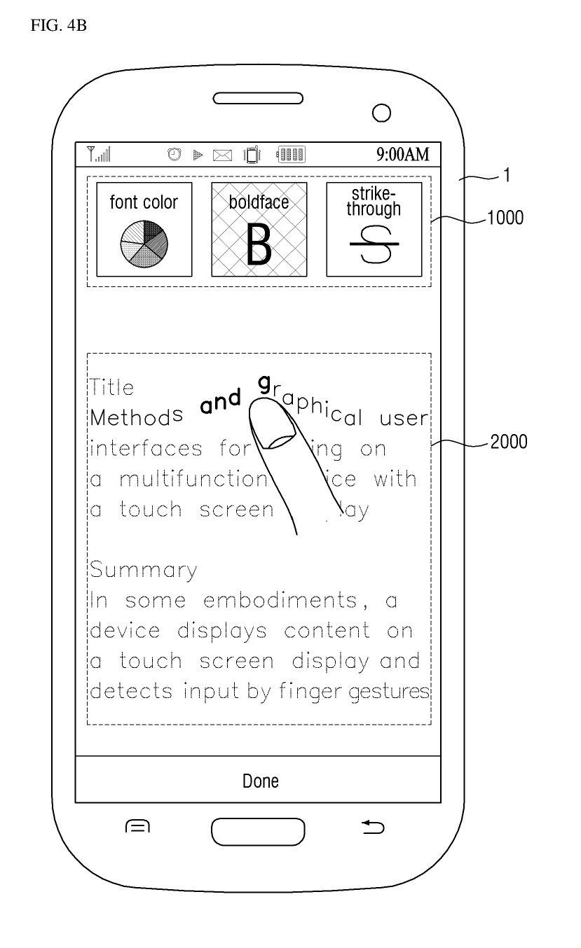

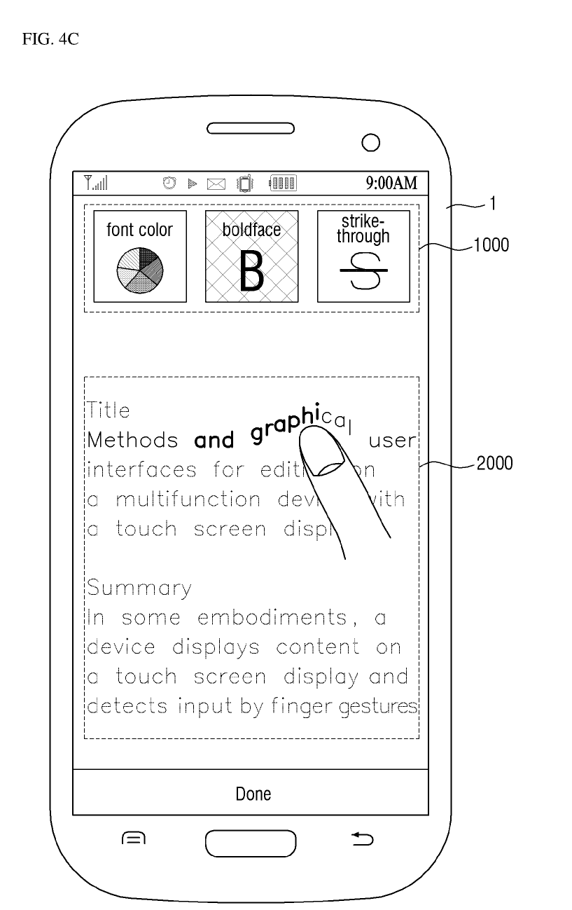

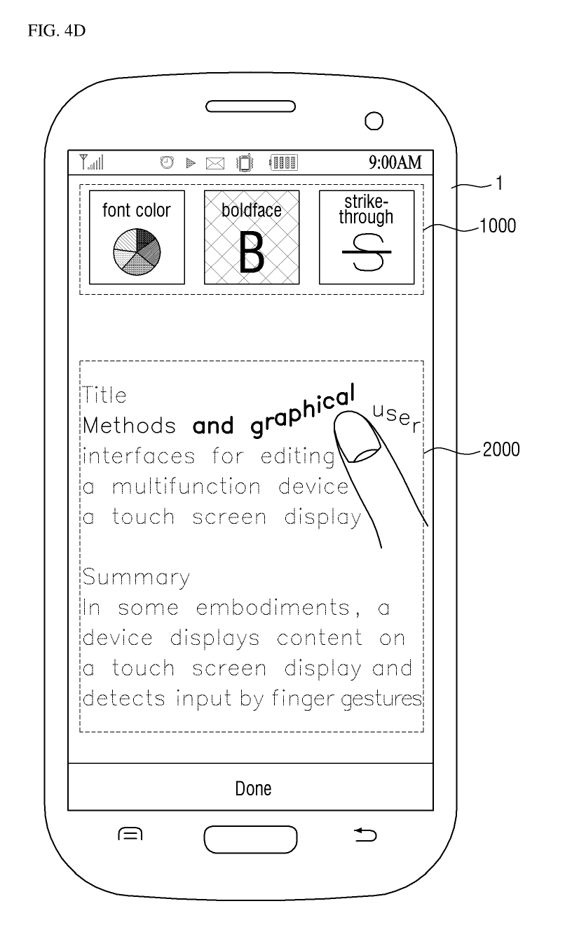

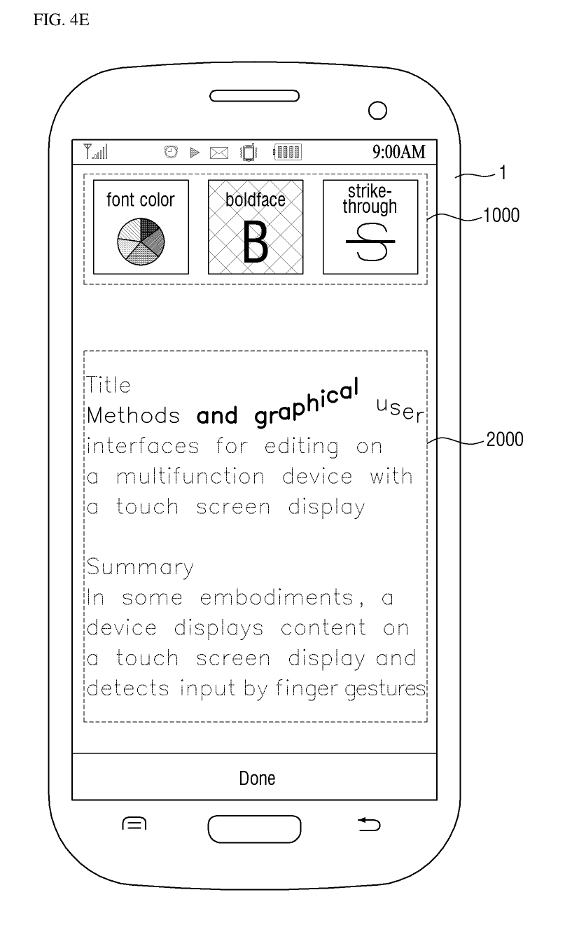

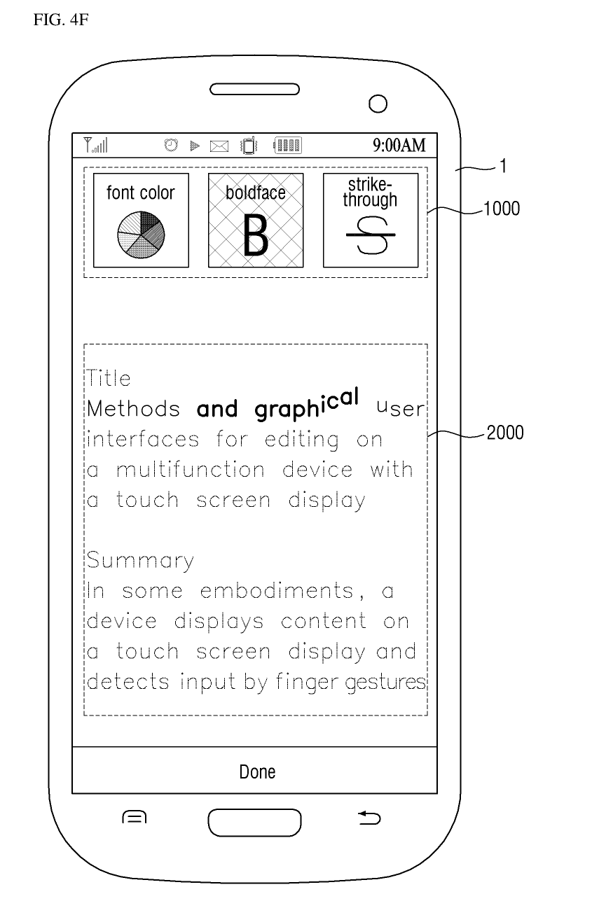

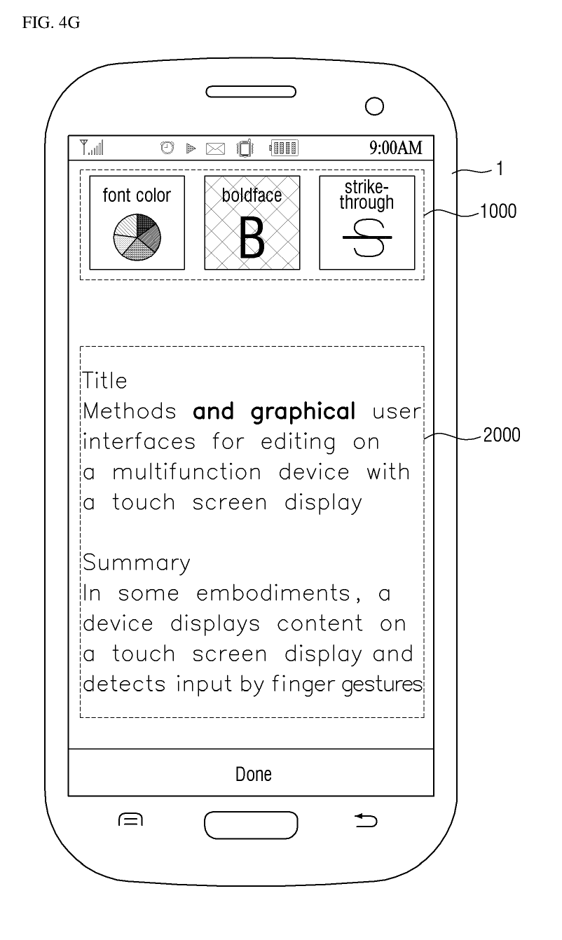

Referring to FIGS. 4A through 4G, when the touch point is moved to the right, the coordinates of each character are changed, and an animation effect of moving the shape in which each character sticks out to the right in accordance with the moving direction of the touch point may be displayed via the display unit 100, and at the same time, a character for which the user's touch gesture is determined as being the first touch gesture may be edited in accordance with a selected editing mode, and the edited character may be displayed by the display unit 100.

For example, as illustrated in FIG. 4, the color of each character may be turned from black to red.

Meanwhile, when the user's touch gesture is determined as being the second touch gesture by the touch gesture determination unit 400, the editing unit 500 may display an animation effect for the character corresponding to the coordinates of the touch point and may thus cancel editing of the character.

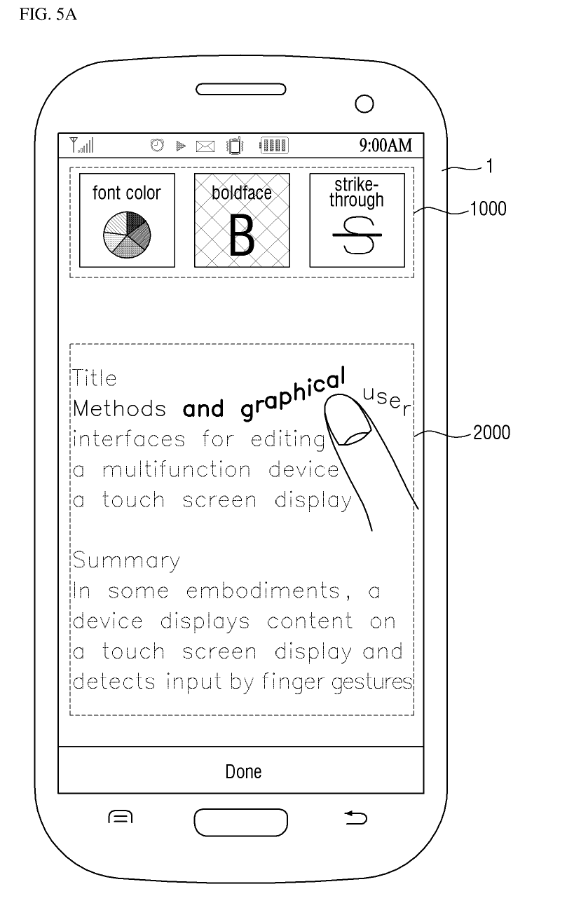

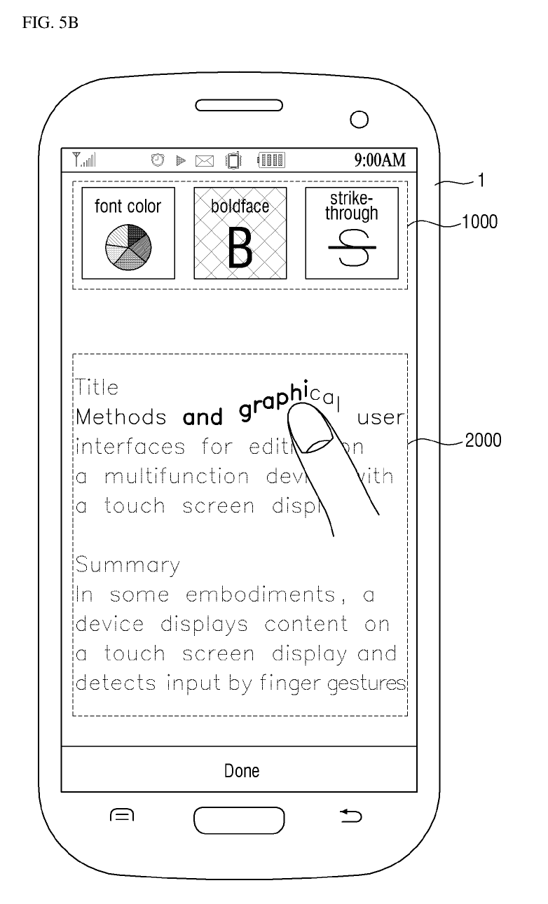

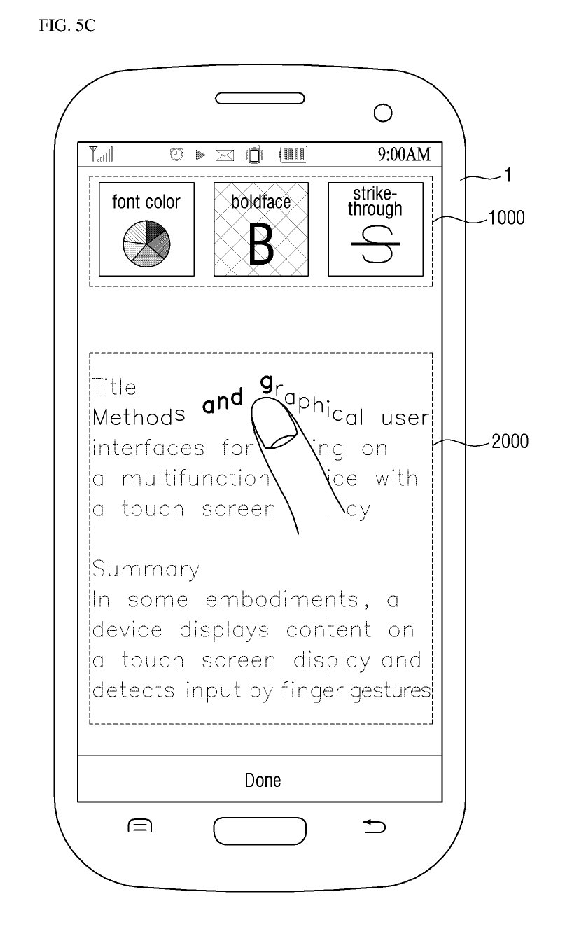

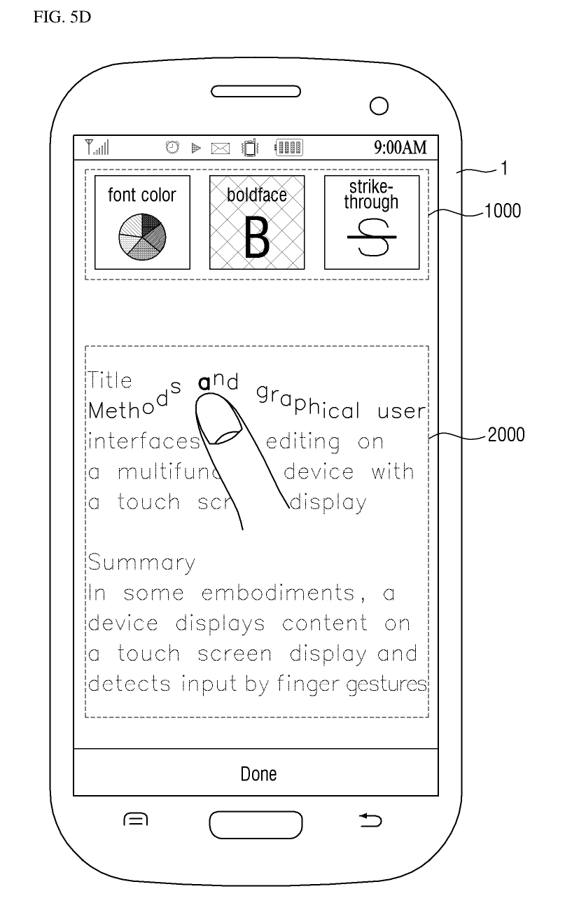

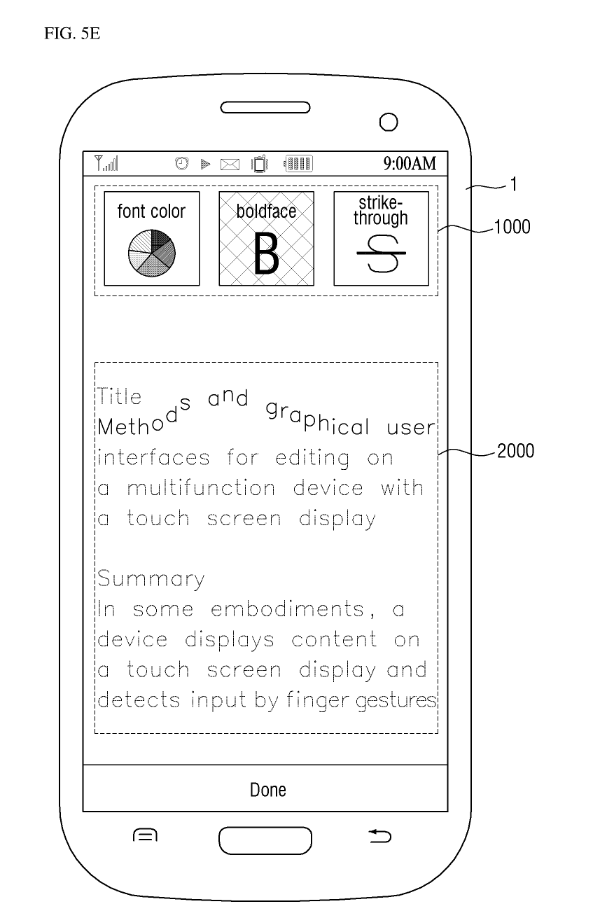

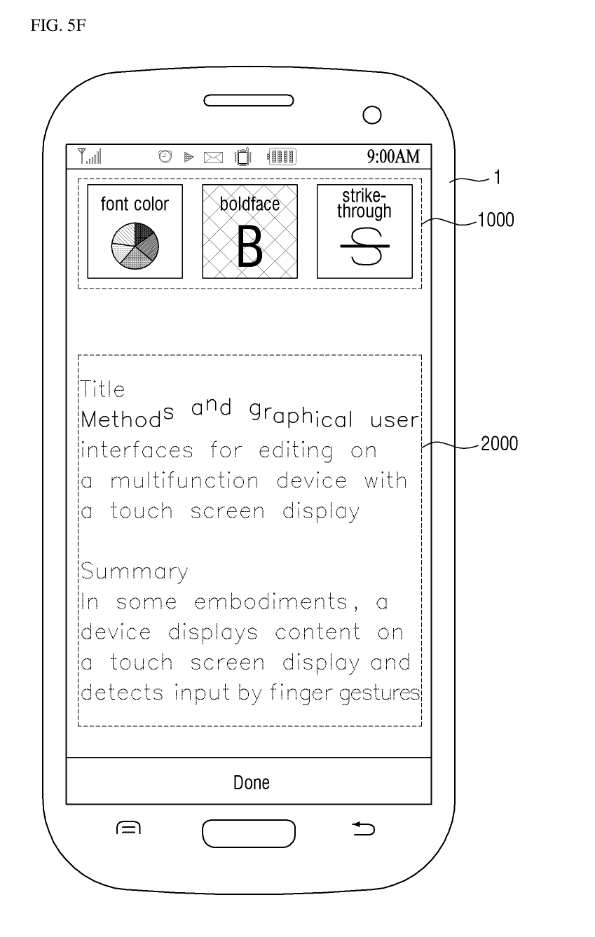

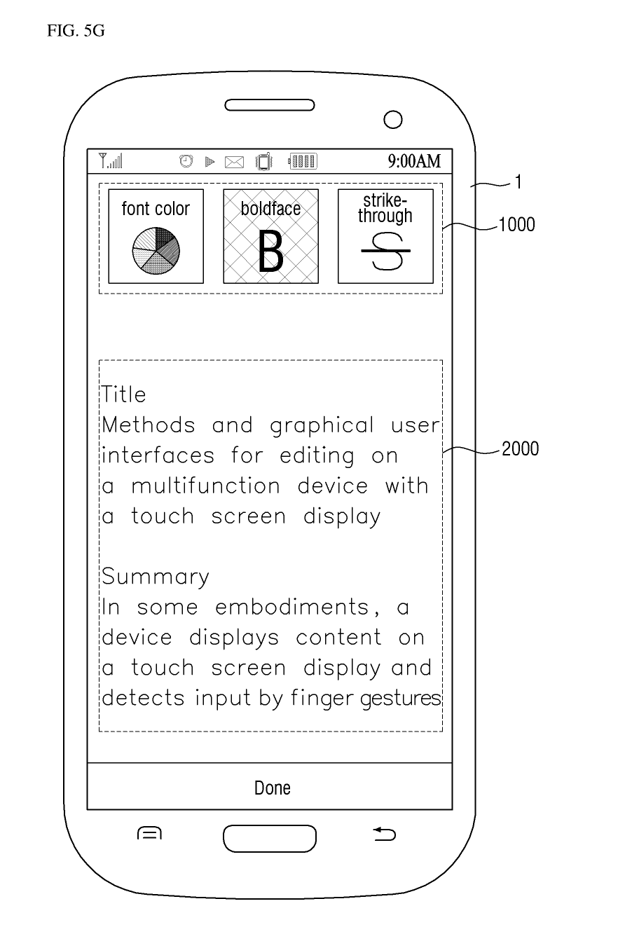

Referring to FIGS. 5A through 5G, when the touch point is moved to the left, the coordinates of each character are changed, and an animation effect of moving the shape in which each character sticks out to the left in accordance with the moving direction of the touch point may be displayed via the display unit 100, and at the same time, an editing-canceled character may be displayed via the display unit 100 for a character for which the user's touch gesture is determined as being the second touch gesture.

For example, as illustrated in FIG. 5, the color of each character may be turned back to black, which is the default color.

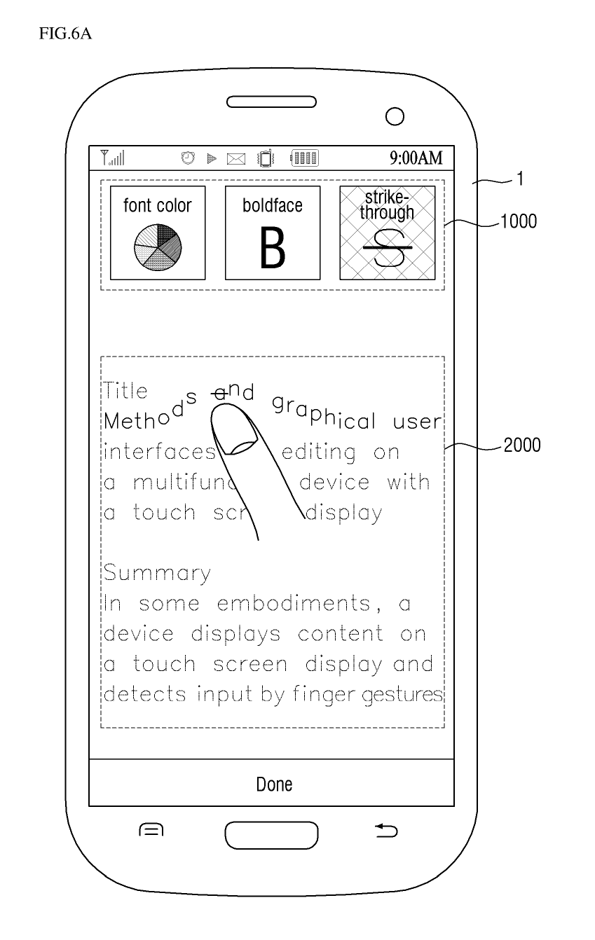

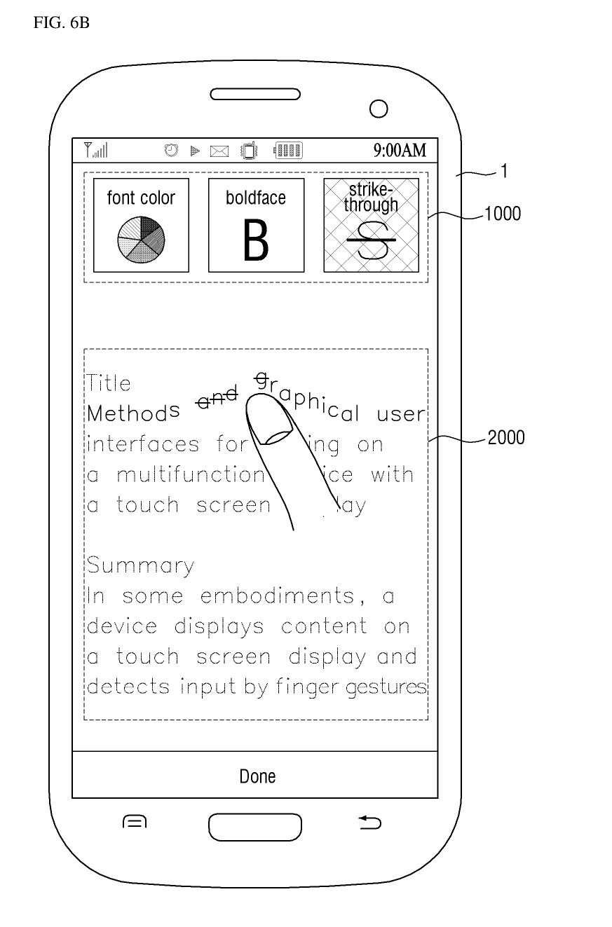

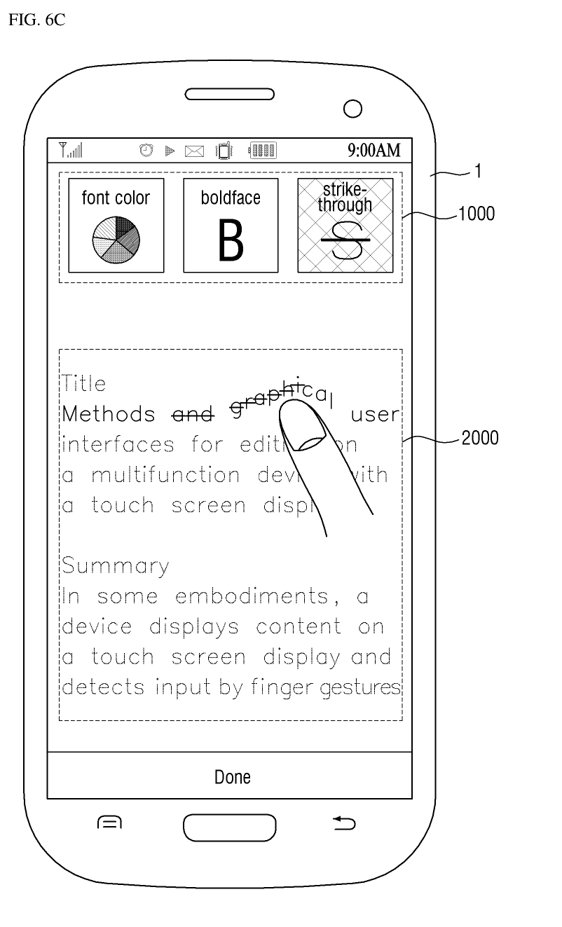

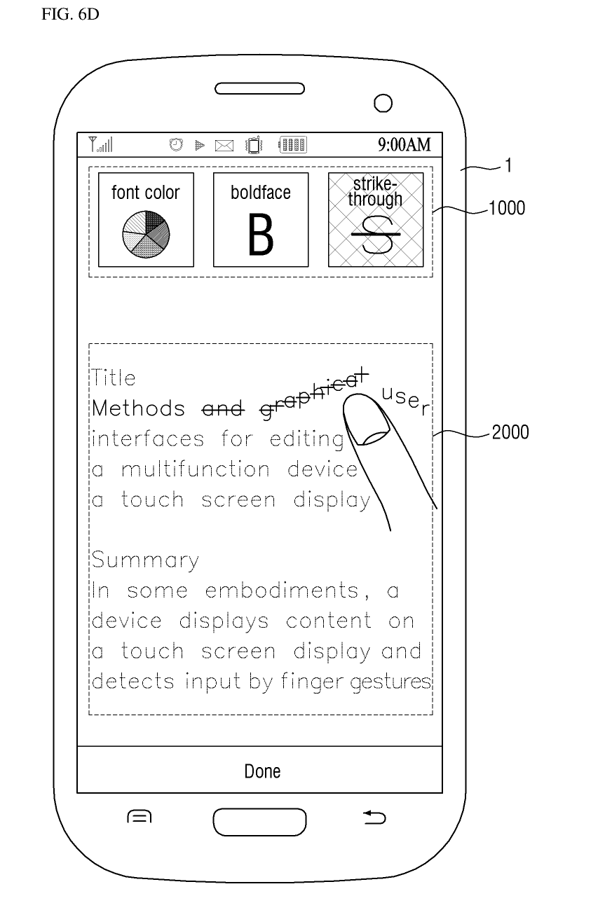

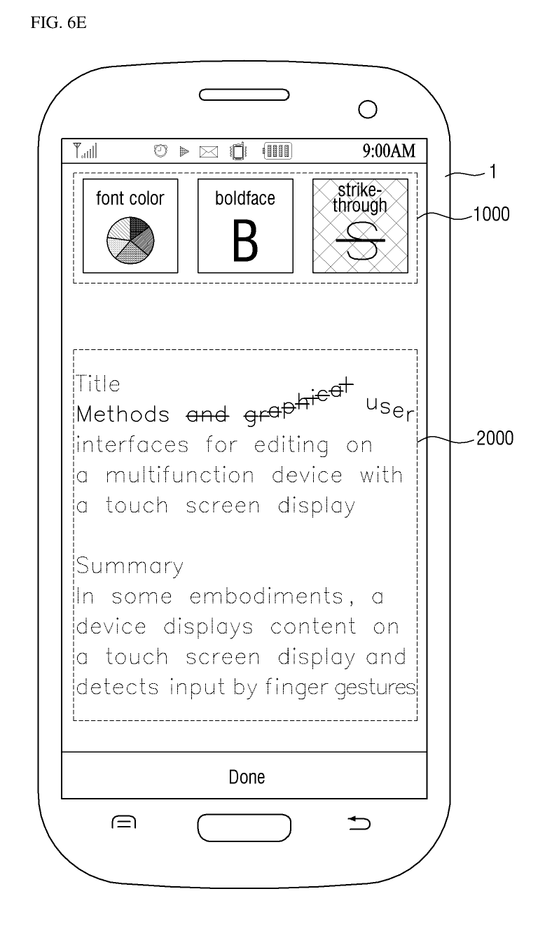

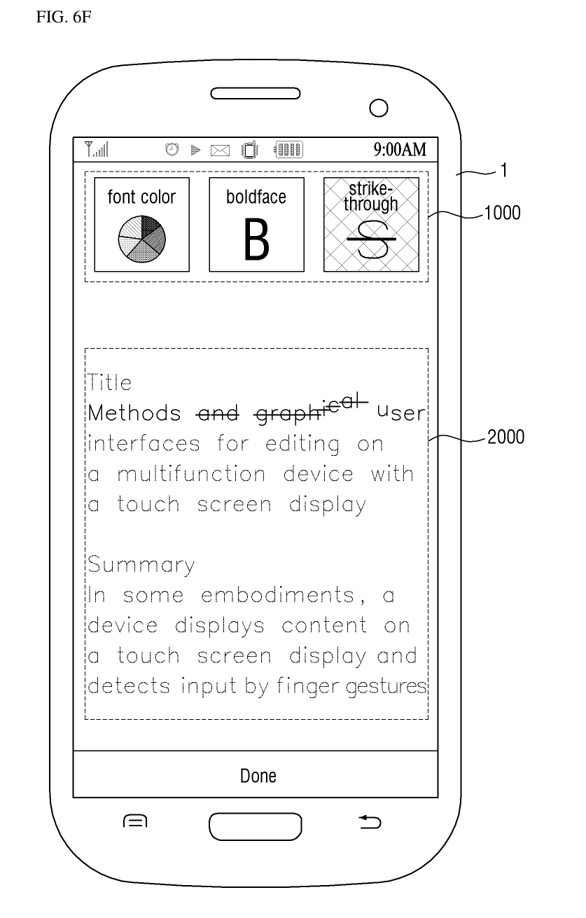

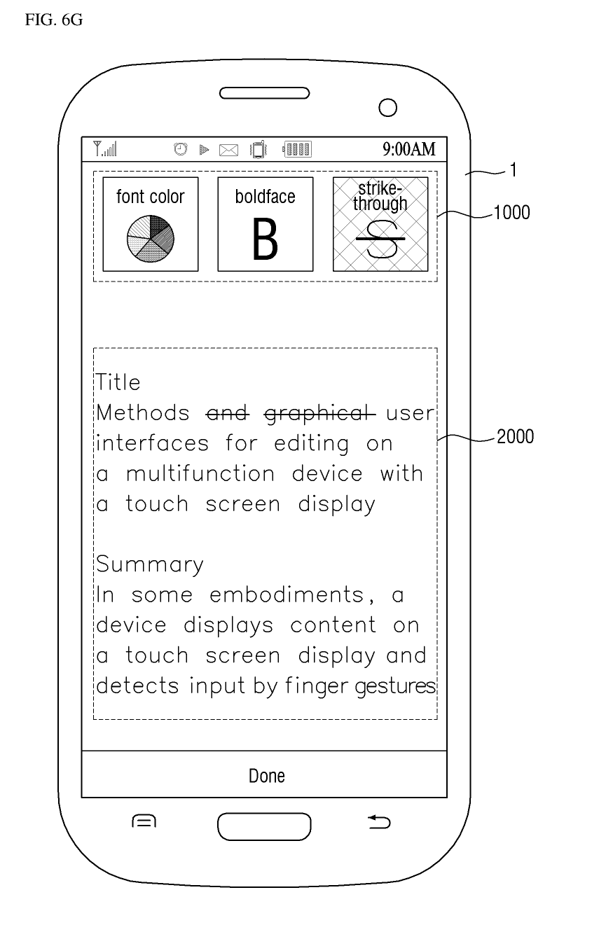

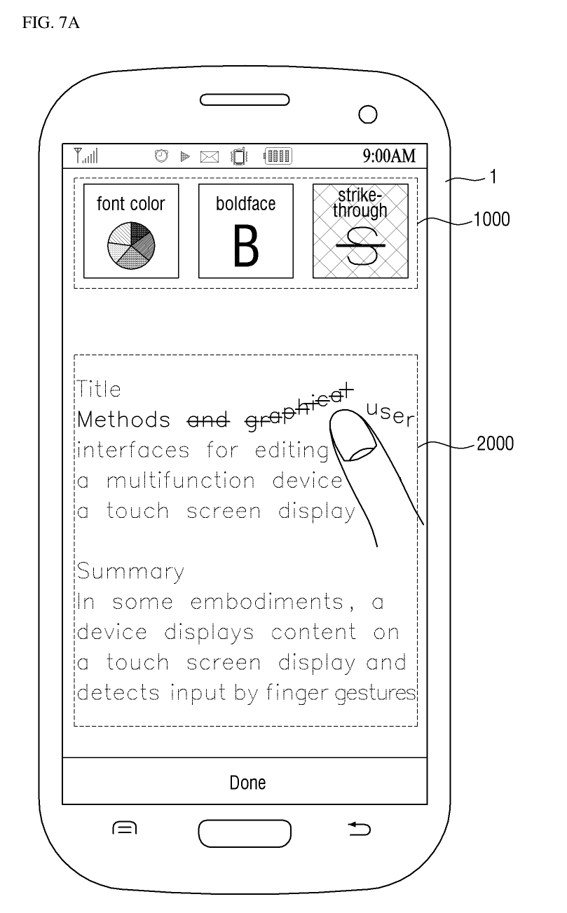

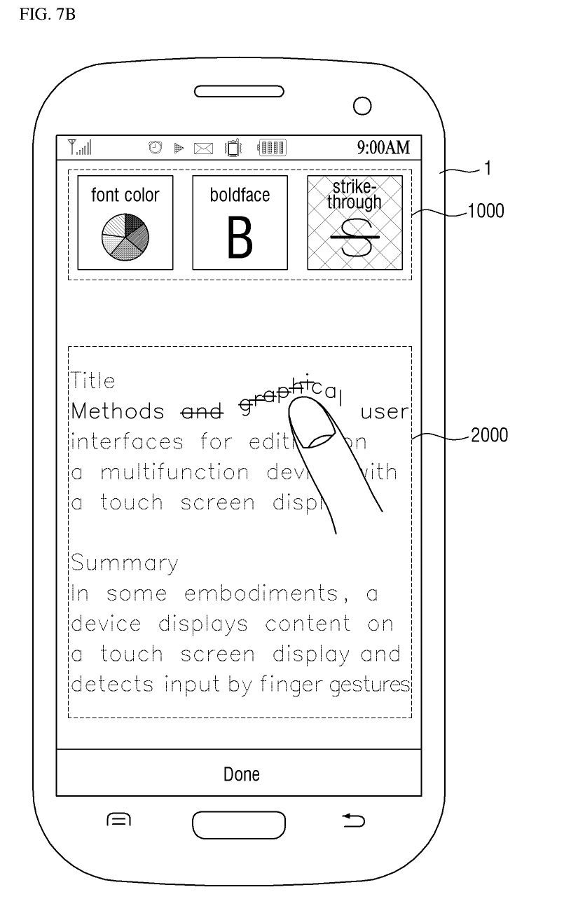

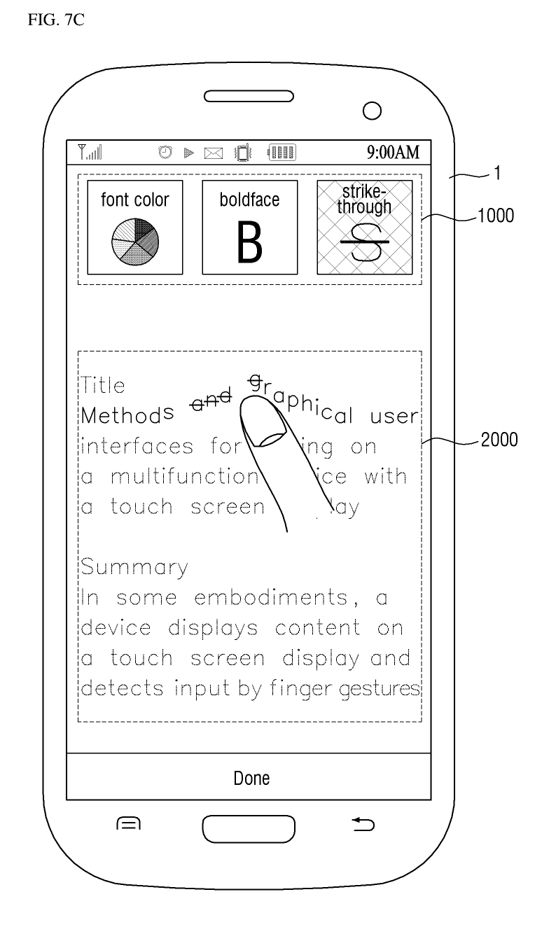

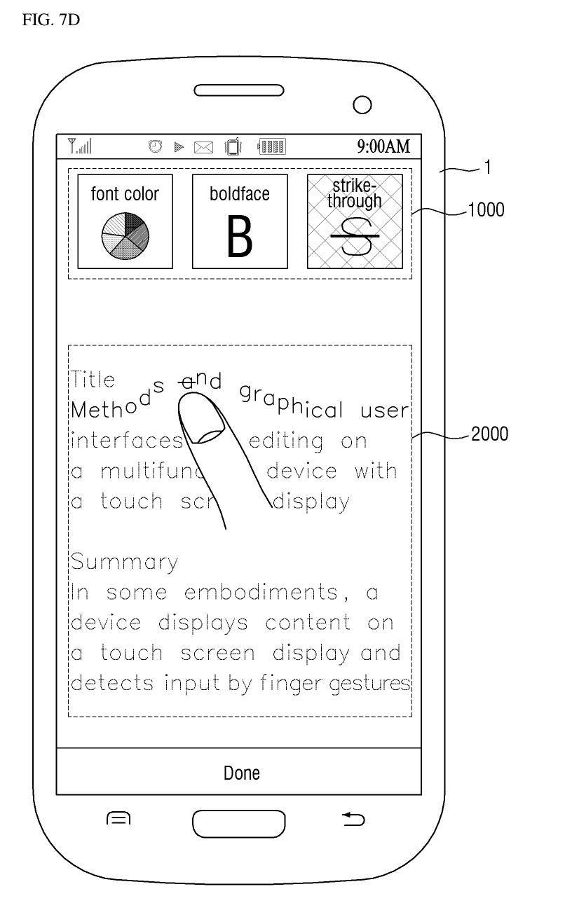

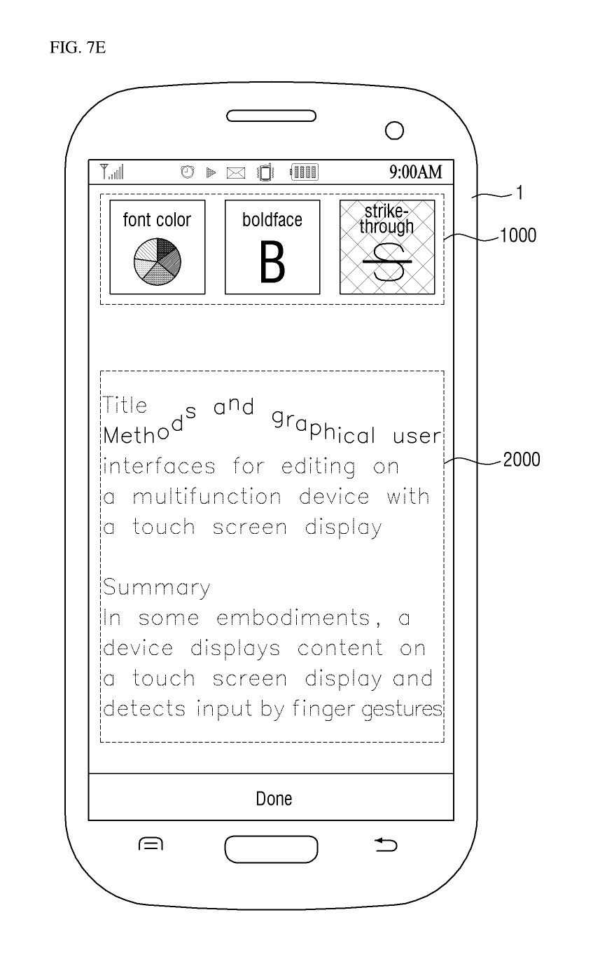

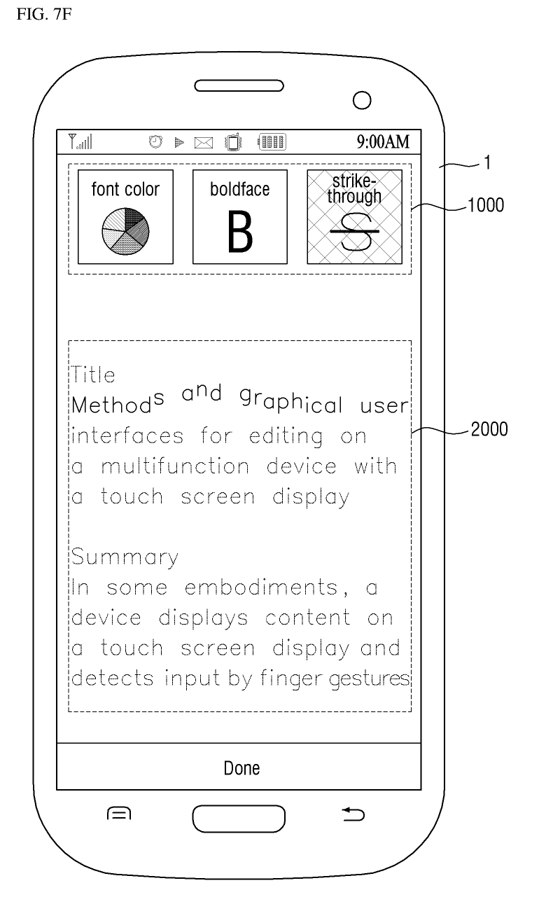

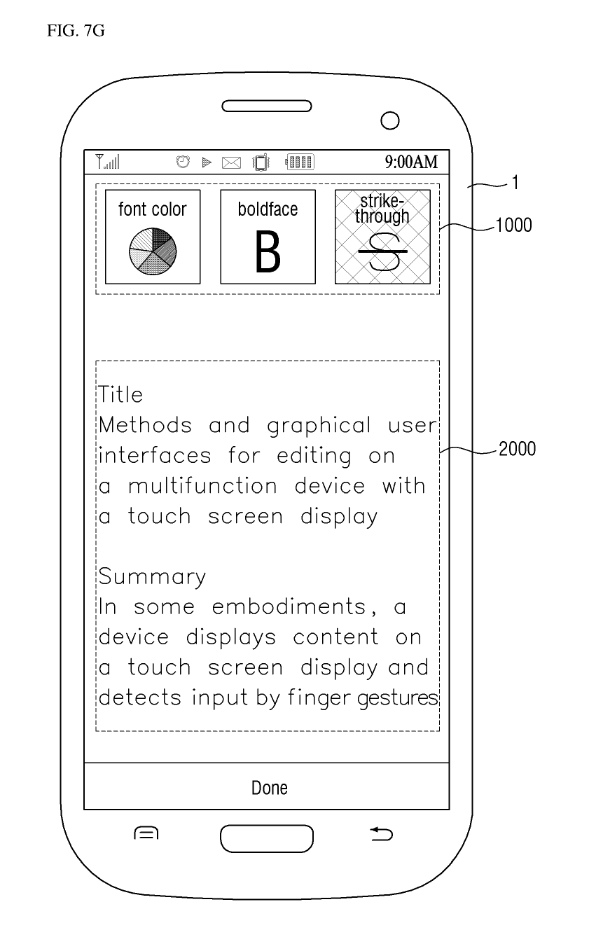

Meanwhile, according to another exemplary embodiment of the present inventive concept, character editing may be performed not only to change the color of each character, but also to apply a strikethrough to each character, as illustrated in FIGS. 6 and 7.

Also, the editing unit 500 may apply a visual effect to characters, other than a character to which an animation effect is applied, so that the characters can become distinguishable from the character to which an animation effect is applied.

The visual effect may change at least one of the following attributes: transparency, font color, font size, and a shading effect.

Specifically, the editing unit 500 may set the transparency of characters, other than a character to which an animation effect caused by a touch gesture is applied, differently, thereby displaying the corresponding characters dimly.

Accordingly, by highlighting the character corresponding to the coordinates of the touch point, the readability of the character being edited can be improved so that the user can clearly identify which character is being edited.

Transparency (alpha) may be defined by the following equations.

$$Transparency ( alpha ) = 1 - \frac{0.7}{T} \times t ( 0 < t < T ) ; and$$

$$Transparency ( alpha ) = 0.3 ( t \geq T )$$

The editing unit 500 may change at least one of the size, location, transparency, and font of the character corresponding to the coordinates of the touch point so that the character can become distinguishable from neighboring characters.

That is, the editing unit 500 may set the size, location, font, or transparency of a character corresponding to a location currently being touched differently from other characters.

The editing unit 600 may carry out this effect by adding k to the existing equation S₁ to change the height of the character corresponding to the touched location or by changing the corresponding character to boldface.

S₁: y′ₜ=h×cos((π/2)·α·x)×p+yₜ+k

The location or the font of the character at the touched location is changed in order to precisely indicate a character currently being selected by a touch.

Meanwhile, conditions for detecting the character at the touched location are as follows. If the x coordinate of the left side of the character is to the left of the x coordinate Xc of the current touch point and the x coordinate of the right side of the character is to the right of the x coordinate Xc of the current touch point, the attribute (e.g., height or font) of the character may be changed so that the character currently being selected by a touch can be precisely indicated.

Meanwhile, the user can select the type of a function for applying an animation effect, a variable (e.g., effect height) of the function, and an attribute such as transparency, font size, font, or character location.

An animation effect is terminated by determining, by the touch point detection unit 200, whether touch contact of the touch screen no longer exists, and once the animation effect is terminated, characters return to their original locations before the animation effect.

According to one exemplary embodiment of the present inventive concept, when touch contact of the touch screen disappears, characters gradually return to their original locations, and the animation effect is terminated.

Accordingly, the following condition may be applied to the progress p of the equation S₁, which is used for the animation effect.

$$p = 1 - \frac{1}{T} \times t ( 0 < t < T ) , p = 0 ( t \geq T )$$

Also, when touch contact of the touch screen disappears, the transparency (alpha) of characters other than the character to which the animation effect is applied may return from a dim state to a default state, and the following conditions may be applied to transparency (alpha).

$$Transparency ( alpha ) = 0.3 + \frac{0.7}{T} \times t ( 0 < t < T )$$

$$Transparency ( alpha ) = 1 ( t \geq T )$$

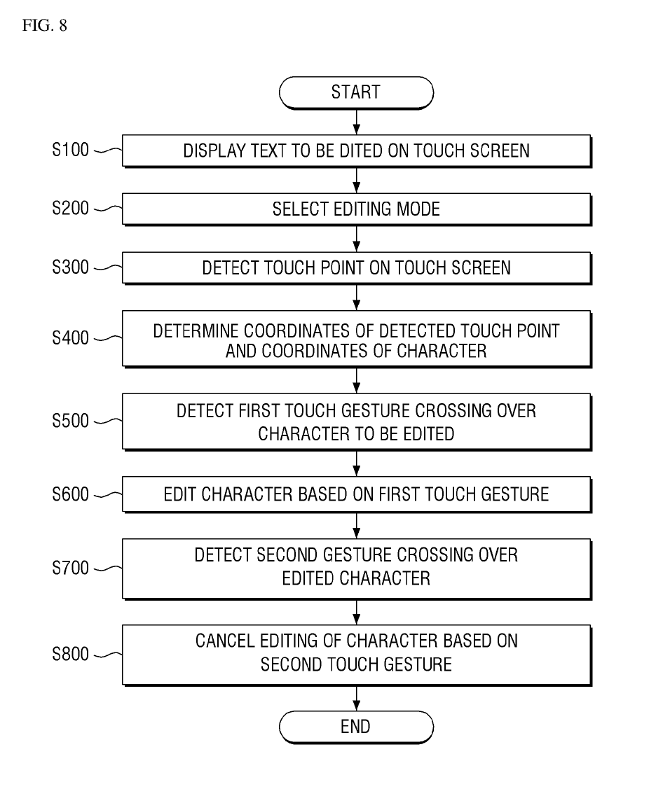

FIG. 8 is a flowchart illustrating a method for editing characters on a smart device including a touch screen, according to an exemplary embodiment of the present inventive concept.

According to one exemplary embodiment of the present inventive concept, the method for editing characters may include displaying text to be displayed on a touch screen (S100), receiving a selection of an editing mode for characters (S200), detecting a touch point on the touch screen (S300), determining the coordinates, on the touch screen, of the detected touch point and the coordinates, on the touch screen, of each character included in the text (S400), detecting a first touch gesture crossing over a character to be edited from the text displayed on the touch screen, based on the determined coordinates (S500), and editing the character displayed on the touch screen, corresponding to the coordinates of the touch point, based on the detected first touch gesture (S600).

The method for editing characters may further include detecting a second touch gesture crossing over a character to be editing-canceled from among edited characters, based on the determined coordinates (S700) and canceling editing of the character displayed on the touch screen, corresponding to the coordinates of the touch point, based on the detected second touch gesture (S800).

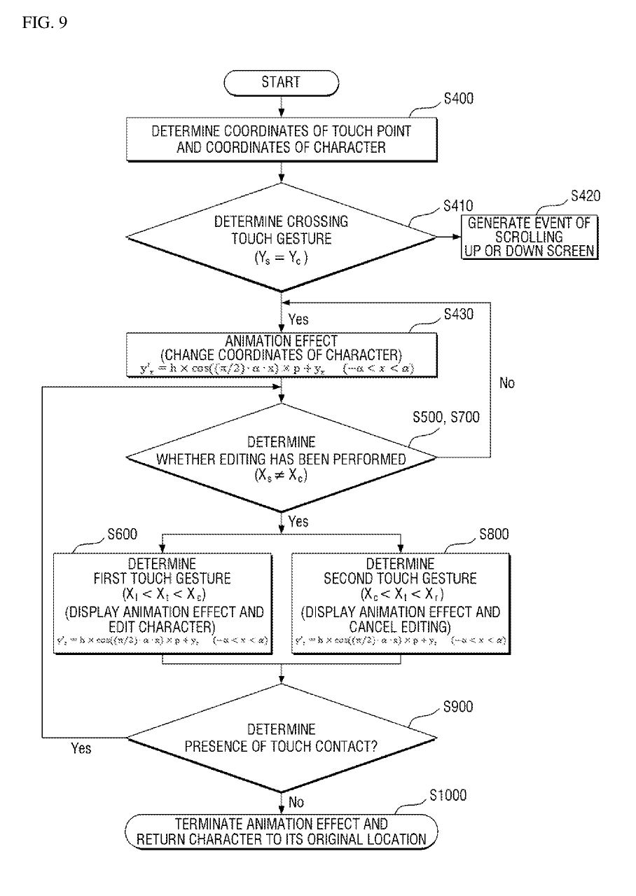

FIG. 9 is a flowchart illustrating a method for editing characters on a smart device including a touch screen, while displaying an animation effect, according to another exemplary embodiment of the present inventive concept.

The step of detecting the first touch gesture or the second touch gesture (S500 or S700) may further include determining a crossing touch gesture first (S410) by determining whether vertical coordinates Ys and Yc of an initial touch point and a current touch point, among a series of touch points, are the same.

If a current touch gesture is not a touch gesture crossing over the touch screen (Ys≠Yc), an event of scrolling up or down the screen is generated first (S420), and if the current touch gesture is a touch gesture crossing over the touch screen (Ys=Yc), an animation effect may be displayed for a character based on the coordinates of a touch point (S430).

According to one exemplary embodiment of the present inventive concept, the method for editing characters may further include determining whether touch contact of touch screen no longer exists (S900) and terminating an animation effect and returning the character to its original location before the animation effect (S1000).

The description of the aforementioned smart device, which edits characters via a touch screen, may be applicable to the methods of editing characters according to exemplary embodiments of the present inventive concept. Thus, the description of the aforementioned smart device will be omitted in the following description.

Referring to FIG. 3, a user interface for editing characters via the touch screen of a smart device according to an exemplary embodiment of the present inventive concept may include an editing mode selection region 1000 and a text display region 2000, and may be characterized in that a character from text displayed on the touch screen, corresponding to the coordinates of a touch point on the text display region 2000, is edited in accordance with an editing mode selected from the editing mode selection region 1000, based on a touch gesture crossing, from the touch point, over the character.

The editing mode selection region 1000 may include icons for types of editing such as boldface, font color change, italic, highlight, shade, strike-through, tilt, crop, copy, and paste.

According to one exemplary embodiment of the present inventive concept, the characters displayed in the text display region 2000 can be edited in accordance with the editing mode selected from the editing mode selection region 1000, while accompanying an animation effect.

Further, the computer-readable medium may include all computer storage media and communication media. The computer storage media include all of volatile and nonvolatile media, and separable and nonseparable media implemented by a method or technology for storing information such as computer-readable instructions, a data structure, a program module, or other data. The communication media generally include a transmission mechanism of computer-readable instructions, a data structure, a program module, other data of a modulated data signal such as a carrier wave, or the like, and include an arbitrary information transmission medium.

The above-described descriptions of the present invention are exemplary, and those skilled in the art of the present invention may understand that the present invention may be embodied in other specific forms without changing the technical spirit or essential characteristics. Accordingly, the above-described embodiments should be understood to be exemplary and not limiting. For example, each component described as a single entity may be distributed and implemented, and components described as being dispersed may be implemented in an integrated form.

The scope of the present invention is shown by the claims rather than the detailed description, and all of variations or different forms derived from the means, scope, and equivalents of the claims should be interpreted to be included in the scope of the present invention.

### DESCRIPTION OF REFERENCE NUMERALS

1: Smart Device

10: User Interface Unit

20: Processor

100: Display Unit

200: Touch Point Detection Unit

300: Coordinate Determination Unit

400: Touch Gesture Determination Unit

500: Editing Unit

1000: Editing Mode Selection Region

2000: Text Display Region

What is claimed is:

1. A method for editing characters on a smart device including a touch screen, comprising:
displaying text to be displayed on the touch screen;
detecting a touch point on the touch screen;
determining coordinates, on the touch screen, of the detected touch point and coordinates, on the touch screen, of each character included in the text;
detecting a first touch gesture crossing over a character to be edited from the text displayed on the touch screen, based on the determined coordinates; and
editing a character displayed on the touch screen, corresponding to the coordinates of the touch point, based on the detected first touch gesture,
wherein
the editing the character, comprises editing the character by displaying an animation effect for the character, and
the animation effect displayed for the character displays the character to stick out above the touch point.

2. The method of claim 1, wherein the displaying the text to be displayed on the touch screen, further comprises receiving a selection of an editing mode for the character.

3. The method of claim 2, wherein the editing mode is at least one of boldface, font color change, italic, highlight, shade, strike-through, tilt, crop, copy, and paste.

4. The method of claim 1, further comprising:
detecting a second touch gesture crossing over a character to be editing-canceled from among edited characters, based on the determined coordinates; and
canceling editing of a character displayed on the touch screen, corresponding to the coordinates of the touch point, based on the detected second touch gesture.

5. The method of claim 4, wherein the detecting the first touch gesture or the second touch gesture based on the determined coordinates, comprises determining a crossing touch gesture first by determining whether vertical coordinates Ys and Yc of an initial touch point and a current touch point, among a series of touch points, are the same.

6. The method of claim 4, wherein
the first touch gesture corresponds to a case where a coordinate Xl of a far left touch point among the series of touch points is to the left of a coordinate Xt of the character and a coordinate Xc of the current touch point is to the right of the coordinate Xt of the character, and
the second touch gesture corresponds to a case where a coordinate Xr of a far right touch point among the series of touch points is to the right of the coordinate Xt of the character and the coordinate Xc of the current touch point is to the left of the coordinate Xt of the character.

7. The method of claim 1, wherein the animation effect changes the coordinates of the character in accordance with a predetermined relationship between the touch point and a distance x between the coordinates of the touch point and the coordinates of the character and an effect height h.

8. The method of claim 7, wherein the predetermined relationship is defined by the following function:
S₁: y′ₜ=h×cos((π/2)·α·x)×p+yₜ(−α<x<α)
{cf. y′ₜ=character vertical coordinate after change; yₜ=character vertical coordinate before change;
h=effect height; α=function cycle;
is x=current touch point (X_{c})-horizontal coordinate (Xₜ) of character;
p=1/T×t; T is optional}.

9. The method of claim 1, further comprising:
applying a visual effect to characters, other than the character to which the animation effect is applied, so that the characters can become distinguishable from the character to which the animation effect is applied.

10. The method of claim 9, wherein the visual effect changes at least one of transparency, color, size, and a shading effect.

11. The method of claim 1, further comprising:
changing at least one of the size, location, transparency, and font of a character corresponding to the coordinates of the current touch point so that the character can become distinguishable from neighboring characters.

12. A smart device editing characters via a touch screen, comprising:
a display unit displaying text on the touch screen;
a touch point detection unit detecting a touch point on the touch screen;
a coordinate determination unit determining coordinates, on the touch screen, of the detected touch point and coordinates, on the touch screen, of each character included in the text;
a touch gesture detection unit detecting a first touch gesture crossing over a character to be edited from the text displayed on the touch screen, based on the determined coordinates; and
an editing unit editing a character displayed on the touch screen, corresponding to the coordinates of the touch point, based on the detected first touch gesture,
wherein
the editing unit edits the character displayed on the touch screen, corresponding to the coordinates of the touch point, based on the detected first touch gesture by displaying an animation effect for the character, and
the animation effect displayed for the character displays the character to stick out above the touch point.

13. The smart device of claim 12, wherein
the touch gesture determination unit detects a second touch gesture crossing over a character to be editing-canceled from the text displayed on the touch screen, based on the determined coordinates, and
an animation effect displayed for the character to be editing-canceled displays the character to be editing-canceled to stick out above the touch point.

14. The smart device of claim 13, wherein the touch gesture determination unit determines a crossing touch gesture first by determining whether vertical coordinates Ys and Yc of an initial touch point and a current touch point, among a series of touch points, are the same.

15. The smart device of claim 12, wherein the touch gesture determination unit determines a current touch gesture as being the first touch gesture if a coordinate Xl of a far left touch point among the series of touch points is to the left of a coordinate Xt of the character and a coordinate Xc of the current touch point is to the right of the coordinate Xt of the character, and determines the current touch gesture as being the second touch gesture if a coordinate Xr of a far right touch point among the series of touch points is to the right of the coordinate Xt of the character and the coordinate Xc of the current touch point is to the left of the coordinate Xt of the character.

16. The smart device of claim 12, wherein the animation effect changes the coordinates of the character in accordance with a predetermined relationship between the touch point and a distance x between the coordinates of the touch point and the coordinates of the character and an effect height h.

17. The smart device of claim 16, wherein the predetermined relationship is defined by the following function:
S₁: y′ₜ=h×cos((π/2)·α·x)×p+yₜ(−α<x<α)
{cf. y′ₜ=changed character vertical coordinate; yₜ=original character vertical coordinate;
h=effect height; α=function cycle;
x=current touch point (X_{c})-character horizontal coordinate (Xₜ);
p=1/T×t; T is optional}.

18. The smart device of claim 12, wherein the editing unit applies a visual effect to characters, other than the character to which the animation effect is applied, so that the characters can become distinguishable from the character to which the animation effect is applied.

19. The smart device of claim 18, wherein the visual effect changes at least one of transparency, color, size, and a shading effect.

20. A user interface for editing characters via a touch screen of a smart device, comprising:
a text display region; and
an editing mode selection region,
wherein
a character from text displayed on the touch screen, corresponding to coordinates of a touch point on the text display region, is edited in accordance with an editing mode selected from the editing mode selection region, based on a touch gesture crossing, from the touch point, over the character,
the character displayed in the text display region is edited in accordance with the editing mode selected from the editing mode selection region, while accompanying an animation effect, and
the animation effect makes the character stick out above the touch point.
